(19) United States
(12) Patent Application Publication
(10) Pub. No.: US 2002/0010929 A1
(43) Pub. Date: Jan. 24, 2002

(54) Device for and method of presenting program information

(76) Inventor: Rene Pierre Gaston Collier, Eindhoven (NL)

Correspondence Address: Corporate Patent Counsel, U.S. Philips Corporation, 580 White Plains Road, Tarrytown, NY, 10591, US

(21) Appl. No.: 09/901,291

(22) Filed: Jul. 9, 2001

(30) Foreign Application Priority Data
Jul. 10, 2000 (EP) 00202453.7

(51) Int. Cl. G06F 3/00

(52) U.S. Cl. 725/40

(57) ABSTRACT

A device (100) presents to a user information about programs that are selected from a number of programs. The selection is done by a selection unit 112 on the basis of a program genre specified by the user. To this end, each program has a label that identifies the genre of that program and the user specifies a label that corresponds with the currently preferred genre. According to the invention, the device (100) has a label assignment unit (116) with which the user can assign a label (606) to a program genre (601). In this way, the user can choose or create a personal label for a program genre.

The invention relates to a device for presenting to a user information about a selection of programs, the device comprising: a specification unit for letting the user specify a preferred genre from a plurality of program genres by letting the user select a label from a plurality of labels, each label corresponding to a respective one of the program genres; a selection unit for making the selection of programs from a plurality of programs on the basis of the preferred genre; and a presentation unit for presenting the information about the selection of programs.

The invention further relates to a television receiver comprising such a device.

The invention further relates to a set-top box comprising such a device.

The invention further relates to a program storage apparatus comprising such a device.

The invention further relates to a method of presenting to a user information about a selection of programs, the method comprising the steps of: letting the user specify a preferred genre from a plurality of program genres by letting the user select a label from a plurality of labels, each label corresponding to a respective one of the program genres; making the selection of programs from a plurality of programs on the basis of the preferred genre; and presenting the information about the selection of programs.

U.S. Pat. No. 6,005,601 describes a system that displays a so-called electronic program guide on a display screen. Such an electronic program guide contains information like title and start time of programs that are to be broadcast. In this system, a user can make a selection of the programs for which information is to be displayed. An example of such a selection is where the user specifies a certain date and the system subsequently displays the program information for the programs that are scheduled to be broadcast on that date. Another selection criterion in that system is the program genre. The system displays the available program genres and the user chooses the genre of the program for which information is to be displayed. A list with the textual labels “MOVIE”, “SPORT”, “NEWS”, “MUSIC”, “DRAMA” and “CHILDREN” is displayed. The user moves a cursor in the form of a box over the list and the label that is in the box indicates the program genre of interest.

It is an object of the invention to provide a device as described in the preamble with an improved mechanism for selecting the program genre. This object is achieved according to the invention in a device that is characterized in that the device further comprises a label assignment unit which allows the user to assign a particular label to a particular program genre, so as to make the particular label correspond to the particular program genre for the purpose of specifying the preferred genre. The user is now able to choose a label of his liking for identifying a particular program genre. For selecting the particular program genre the personally chosen label will be used rather than some label that has been predetermined by the designer of the device. Such a personally chosen label makes it easier for the user to know what program genre is represented by a given label.

A further advantage is that the user is able to use the same labels for different types of programs. For example, the user can use the same labels for TV programs received from the external broadcaster as for a personal collection of video material recorder with a camcorder. The user can then have a set of labels that is consistent across the different application. Especially, as in the above example, where some of the programs are received from an external source, the freedom offered by the invention to choose personal labels is highly advantageous.

An embodiment of the device according to the invention is described in claim 2. Choosing one label from a group of labels is an easy way to specify a particular label. This makes it possible to choose a personal label while it is not necessary to fully create a label from scratch.

An embodiment of the device according to the invention is described in claim 4. A pictorial label is user friendly and intuitive since the appearance of the pictorial label, i.e. the meaning of the picture, may give an indication of the program genre represented by the label. For example, a pictorial label being a picture of a person dressed in sportswear intuitively corresponds to the program genre ‘sports’ and a pictorial label being a picture of a soccer player is easily remembered as the label for the sub-genre ‘soccer’. Furthermore, a pictorial label is language independent and to a large extent culture independent.

It is a further object of the invention to provide a method as described in the preamble in which the selection of the program genre is improved. This object is achieved according to the invention in a method that is characterized in that the method further comprises an initialization step in which the user is allowed to assign a particular label to a particular program genre, so as to make the particular label correspond to the particular program genre for the purpose of specifying the preferred genre.

The invention and its attendant advantages will be further elucidated with the aid of exemplary embodiments and the accompanying schematic drawings, wherein:

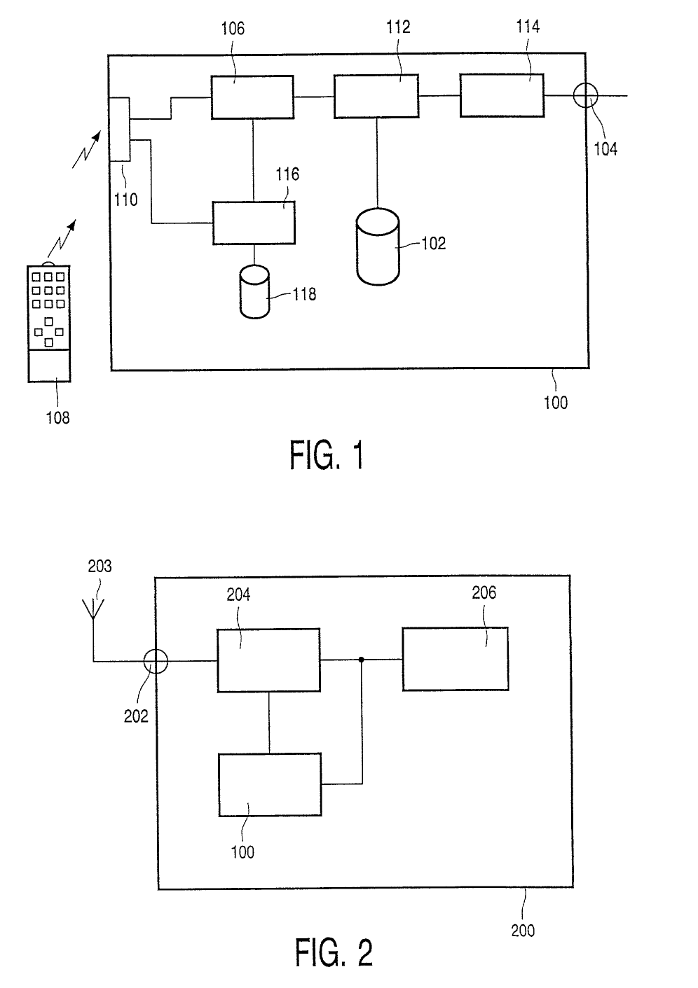

FIG. 1 schematically shows a device according to the invention,

FIG. 2 schematically shows a television receiver according to the invention,

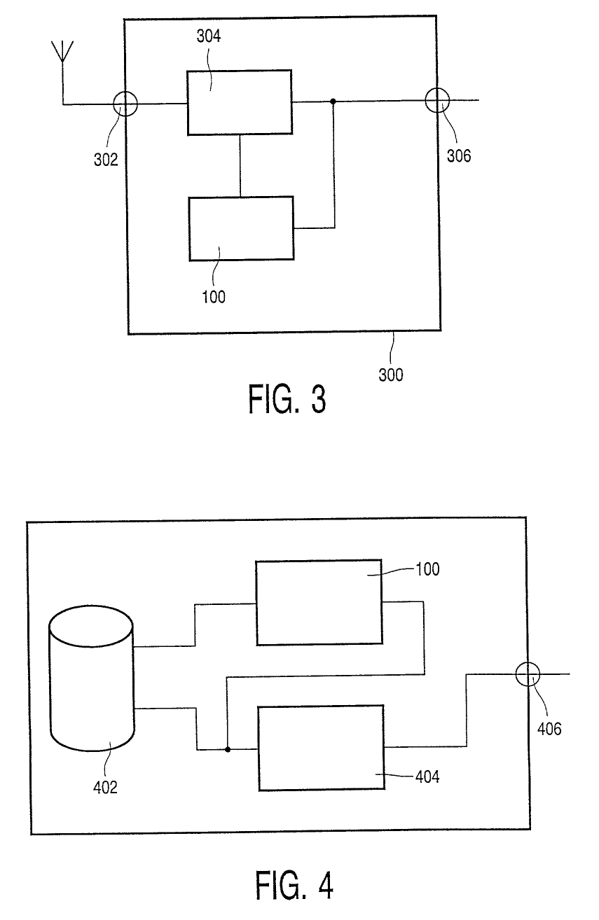

FIG. 3 schematically shows a set-top box according to the invention,

FIG. 4 schematically shows a program storage apparatus according to the invention,

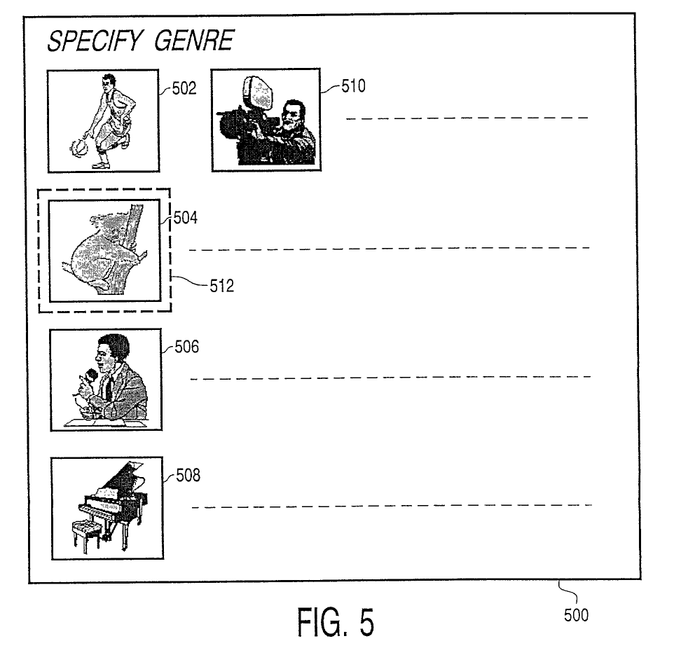

FIG. 5 illustrates the specification of the program genre in an embodiment of the device according to the invention, and

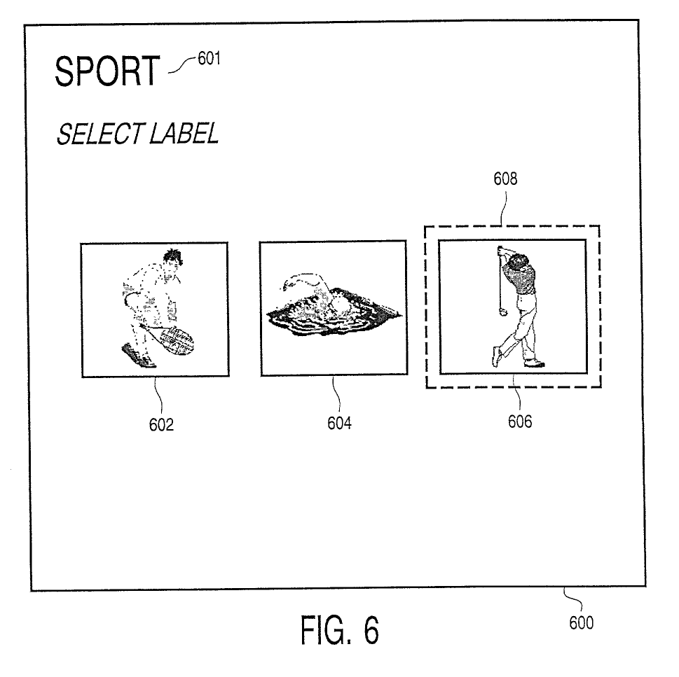

FIG. 6 illustrates the label assignment in an embodiment of the device according to the invention.

Corresponding features in the various Figures are denoted by the same reference symbols.

FIG. 1 schematically shows a device according to the invention. The device 100 includes a database 102 containing information about a potentially large number of programs. The device 100 extracts information for a selection of these programs from the database and outputs this information via an output 104 to be presented to a user. This presentation will typically be done on some display screen. The information about the programs relates to various program characteristics like program title and program duration and may also relate to the program contents like the actors and director if such is applicable. The device allows the user to make a selection from the programs available in the database 102 on the basis of the program genre. To this end, the device 100 has a specification unit 106 with which the user indicates the currently preferred program genre. The specification unit can be implemented in various ways. An example is to display a list of the available genres and to let the user select one genre. To this end, the device displays a list of labels, whereby each label represents a respective program genre, and allows the user to select one label by pointing and clicking. The labels may be small pictures, like icons, whereby the picture is suggestive for the corresponding genre but may also be textual labels expressing the corresponding genres in one or more words. The selection of the program genre of interest may be done hierarchically. For example, at the highest level the user can choose the genre ‘sport’ and subsequently can choose at the next lower level the kind of sport, e.g. ‘darts’, ‘field hockey’, ‘tennis’. The invention can also be applied to the labels at a lower level in such a hierarchy, which represent sub-genres rather than genres. So in this text, reference to program genre and reference to program sub-genre are to be regarded the same for explaining the invention.

The user makes his selection through a suitable input device like a remote control 108. The signals of the remote control are received in interface 110 of the device and the corresponding commands are fed to the specification unit 106. The device has a selection unit 112 that selects the information about the programs in database 102 on the basis of the specified program genre of interest. Subsequently, the information about this selection of programs is assembled into a suitable layout by a presentation unit 114 and output for presenting to the user. The device 100 has a label assignment unit 116 with which the user assigns labels to respective program genres. The result of the assignment of a label to a program genre is that the label then corresponds with the program genre and that the label is the representative for that program genre for the purpose of selecting programs on the basis of the program genre. In operating the device, it means that if the user selects a label the corresponding program genre becomes the preferred program genre which is used by selection unit 112 for making the selection of program information from the database 102. The label assignment unit 116 allows the user to define a personal label for a given program genre. This flexibility makes that it is easier for the user to specify the preferred program genres, since he will more readily remember and understand the program genres corresponding with personally defined labels. Defining a label may be implemented in one of various ways. A textual label can simply be created by a text editor allowing the user to create a string. Letters can be entered via a keyboard, if that is available for the device, or can be chosen with the remote control by point and click letters from an alphabet shown on the display screen. A pictorial label can be created by assembling it from elementary graphical elements using a graphic editor or may even be drawn from scratch with a drawing tool. In an embodiment, the device has a storage unit 118 that comprises a number of available labels from which the user can choose a particular label he likes. Through the label assignment unit, this label is then assigned to the particular program genre currently being processed. Additionally, the device may allow that the label selected from the storage unit 118 is (slightly) amended prior to it being assigned to a program genre.

FIG. 2 schematically shows a television receiver according to the invention. The television receiver 200 receives a video signal carrying one or more programs at input 202. The video signal may be received from an antenna 203 receiving a broadcast signal or from a cable. Alternatively, the video signal may be supplied by a storage device like a Video Cassette Recorder (VCR) or a Digital Versatile Disk (DVD) player which reproduces a stored video program via the television receiver 200. The video signal is received in a receiving unit 204. The receiving unit 204 is arranged to tune to a certain channel for selecting a particular program from the video signal and to process the selected channel signal to be displayed on display device 206. Furthermore, the television receiver 200 contains a device 100 for presenting program information as described above. The program information is presented on display device 206. This may be done in an overlay mode, in which the information is displayed in overlay on the displayed program. However, it is preferably displayed in a separate mode on the display device, in which the display of the program is halted and the program information is exclusively displayed. As described above, the information about the programs is selected from a database in the device. In an embodiment of the television receiver, the information in this database is obtained via the video signal. The provider of the video signal transmits this information in addition to the actual programs and the receiving unit obtains the information from the video signal for storing in the device. The information on programs can be transmitted in a separate channel or can be coded in the video signal of an existing channel in a suitable way. This downloading of information about the program by the service provider is an advantageous way to have up-to-date program information available for the user.

FIG. 3 schematically shows a set-top box according to the invention. The set-top box has an input 302 for receiving a video signal from an antenna or cable. The set-top box has a receiving unit 304 that selects a certain channel and processes the program signal. This often includes decoding the program signal. The set-top box transmits the program signal via an output 306, usually for further processing and display on a television receiver. The set-top box further contains a device 100 that operates in the same way as described above in connection with FIG. 2.

FIG. 4 schematically shows a program storage apparatus according to the invention. The program storage apparatus 400 has a storage unit 402 in which video programs may be stored. The program storage apparatus has a reproduction unit 404 that retrieves a video program and transmits it via output 406 for display, typically on a television receiver. The program storage apparatus may be a Video Cassette Recorder (VCR) or other digital storing apparatus, containing a hard disk as storage unit, for recording and later reproduction of video material. The program storage apparatus (400) further contains a device 100 as described above. Alternative to storing the program information in database 102, in this embodiment the program information may be stored in the storage unit 402 containing the actual program data itself. The operation of device 100 is similar to what has been described in connection with FIG. 2. According to the invention, the program material stored on apparatus 400 can be labeled for later selection with the personal labels that are easy to remember for the user.

FIG. 5 illustrates the specification of the program genre in an embodiment of the device according to the invention. The device 100 shows a display screen 500 with the labels that are available for specifying the program genre of interest. In the figure, only 5 labels 502-510 are shown for reasons of clarity but in practice more may be used. Furthermore, a highlight 512 is shown which indicates which one of the labels is currently selectable. The user can move this highlight over the various labels, for instance by controlling arrow keys on the remote control. In the figure, the highlight 512 is over label 504 thereby indicating that label may now be selected. The user actually selects a label by pressing a select button on the remote control, which makes that the label that was currently selectable, is selected. The program genre to which the selected label corresponds then becomes the preferred program genre. The embodiment shown in FIG. 2 uses pictorial labels whereby the picture suggests the program genre represented by the label, for example:

Label 502: sport

Label 504: nature

Label 506: talk show

Label 508: music show

Label 510: movie

FIG. 6 illustrates the label assignment in an embodiment of the device according to the invention. The device 100 shows a display screen 600 with the labels that may be selected for assignment to a program genre 601. For clarity reasons, only labels 602, 604 and 606 are displayed. In practice many more labels may be available, possibly covering multiple pages through which the user can browse. With a cursor in the form of a moving highlight 608, the user point to the label he wants to assign to the program genre being processed. In the example of FIG. 6, the program genre ‘sport’ is the current genre for which a label is assigned and the user points to label 606 making it assignable to the genre ‘sport’. If the user is satisfied with the currently highlighted label, he presses a button and thereby assigns the label to the program genre.

The invention has been described using embodiment that have an emphasis towards traditional broadcast television programs. However, the invention can also be applied in other areas where information for certain contents and where the contents can be selected the basis of a genre. An example of such other area is a collection of audio files, each having information like title and performer and each being classified in a particular genre. The invention can then be applied to select files from the collection of audio file. Therefore, the term program is not be understood as being restricted to the traditional television program but relates more generally to objects or files that contain content.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. A device (100) for presenting to a user information about a selection of programs, the device comprising:
a specification unit (106) for letting the user specify a preferred genre from a plurality of program genres by letting the user select a label (504) from a plurality of labels (502-510), each label corresponding to a respective one of the program genres;
a selection unit (112) for making the selection of programs from a plurality of programs on the basis of the preferred genre; and
a presentation unit (114) for presenting the information about the selection of programs;
characterized in that the device further comprises a label assignment unit (116), which allows the user to assign a particular label (606) to a particular program genre (601), so as to make the particular label correspond to the particular program genre for the purpose of specifying the preferred genre.

2. A device (100) as claimed in claim 1, wherein the label assignment unit (116) is arranged to let the user select the particular label from a group of labels.

3. A device (100) as claimed in claim 2, comprising a storage unit (118) for storing the group of labels.

4. A device (100) as claimed in claim 1, wherein the particular label (606) is a pictorial representation of the particular program genre (601).

5. A television receiver (200) comprising:
a receiving unit (204) for receiving a video signal,
a device (100) for presenting information about a selection of programs as claimed in claim 1, and
a display device (206) for displaying the video signal and the information.

6. A set-top box (300) comprising:
a receiving unit (304) for receiving a video signal, and
a device (100) for presenting information about a selection of programs as claimed in claim 1.

7. A program storage apparatus (400) comprising a device (100) as claimed in claim 1.

8. A method of presenting to a user information about a selection of programs, the method comprising:
letting the user specify a preferred genre from a plurality of program genres by letting the user select a label from a plurality of labels, each label corresponding to a respective one of the program genres;
making the selection of programs from a plurality of programs on the basis of the preferred genre; and
presenting the information about the selection of programs;
characterized in that the method further comprises allowing the user to assign a particular label to a particular program genre, so as to make the particular label correspond to the particular program genre for the purpose of specifying the preferred genre.
